(19) United States
(12) Patent Application Publication
(10) Pub. No.: US 2017/0322461 A1
(43) Pub. Date: Nov. 9, 2017

(54) LIQUID CRYSTAL PANEL AND PIXEL STRUCTURE THEREOF

(71) Applicant: WUHAN CHINA STAR OPTOELECTRONICS TECHNOLOGY CO., LTD., Wuhan (CN)

(72) Inventors: Jingfeng XUE, Wuhan (CN); Xin ZHANG, Wuan (CN)

(73) Assignee: WUHAN CHINA STAR OPTOELECTRONICS TECHNOLOGY CO., LTD., Wuhan (CN)

(21) Appl. No.: 14/906,274

(22) PCT Filed: Jan. 7, 2016
(86) PCT No.: PCT/CN2016/070396

§ 371 Date: Jan. 20, 2016

(30) Foreign Application Priority Data
Dec. 15, 2015 (CN) 201510934360.3

(51) Int. Cl. G02F 1/1343; G02F 1/1339; G02F 1/1335; G02F 1/1337; G02F 1/1362

(52) U.S. Cl. CPC G02F 1/134309; G02F 1/133788; G02F 1/13394; G02F 1/136286; G02F 1/133512; G02F 2001/134345; G02F 2001/136222; G02F 2201/121; G02F 2201/122; G02F 2001/134318

(57) ABSTRACT

A liquid crystal panel and a pixel structure thereof are described. The pixel structure has a plurality of pixel units, a plurality of black matrices, a plurality of data lines, a plurality of common electrodes and a plurality of gate lines. The black matrices, the data lines, the common electrodes and the gate lines are all disposed along and overlapped with dark lines of the pixel units for raising an opening rate of the pixel structure, thereby improving a display effect of the liquid crystal panel.

### FIELD OF THE INVENTION

The present invention relates to a liquid crystal display technique field, and more particularly to a liquid crystal panel and a pixel structure thereof.

### BACKGROUND OF THE INVENTION

In the production of thin film transistor liquid crystal screens, there are two main alignment methods: a rubbing alignment and an optical alignment. Static electricity and particles' pollution are produced by the rubbing alignment. The optical alignment is a non-contact alignment technique, which a UV light is irradiated on an alignment film with a particular material, for automatically directing polymers of the alignment film to an irradiation angle of the UV light, thus a problem of using the rubbing alignment method will not be produced.

However, dark lines with a particular shape would be form inside each of pixel units while using the optical alignment method. Please referring to FIG. 1, FIG. 1 is a schematic diagram showing of dark lines in the pixel unit 10. Such dark lines includes a crisscross-shape dark line 12 located at a center of the pixel unit 10 approximately, and vertical-side dark lines 14 and horizontal-side dark lines 16 initiate from each of ends 121 of the crisscross-shape dark line 12 and are extended along and parallel to a vertical side and a horizontal side of the pixel unit 10, that is, there are dark lines in similar “ [symbol] ” or “ [symbol] ” shapes in the entire pixel unit 10. However, an opening rate of the pixel would be affected by these dark lines, which results in a poor display effect of a thin film transistor liquid crystal display screen.

As a result, it is necessary to provide a liquid crystal panel and a pixel structure thereof to solve the problems existing in the conventional technologies.

### SUMMARY OF THE INVENTION

In view of this, the present invention provides a liquid crystal panel and a pixel structure thereof, which can improve an opening rate of the pixel structure.

To achieve the above object of the present invention, an embodiment of the present invention provides a pixel structure, wherein the pixel structure comprises: a plurality of pixel units, a plurality of black matrices, a plurality of data lines, a plurality of common electrodes and a plurality of gate lines. The pixel units are arranged in an array and adjacent to each other, each of the pixel units, as an optical alignment is performed thereon, having: a horizontal dark line, a vertical dark line, a first horizontal-side dark line, a second horizontal-side dark line, a first vertical-side dark line and a second vertical-side dark line. The horizontal dark line is parallel to a horizontal side of the pixel unit. The vertical dark line is parallel to a vertical side of the pixel unit, and the vertical dark line and the horizontal dark line is intersected to form a crisscross shape. The first horizontal-side dark line is extended from an end of the vertical dark line toward a direction parallel to the horizontal dark line. The second horizontal-side dark line is extended from the other end of the vertical dark line toward the direction parallel to the horizontal dark line, wherein an extending direction of the second horizontal-side dark line is opposite to that of the first horizontal-side dark line. The first vertical-side dark line is extended from an end of the horizontal dark line toward a direction parallel to the vertical dark line. The second vertical-side dark line is extended from the other end of the horizontal dark line toward the direction parallel to the vertical dark line, wherein an extending direction of the second vertical-side dark line is opposite to that of the first vertical-side dark line. The black matrices are disposed along and overlapped with the first vertical-side dark line and the second vertical-side dark line of the pixel units. The data lines are disposed along and overlapped with the first vertical-side dark line and the second vertical-side dark line of the pixel units. The common electrodes are disposed along and overlapped with the first horizontal-side dark line and the second horizontal-side dark line of a part of the pixel units. The gate lines are disposed along and overlapped with the first horizontal-side dark line and the second horizontal-side dark line of the other part of the pixel units, wherein the gate lines and the common electrodes are alternately arranged and parallel to each other, wherein the horizontal dark line and the vertical dark line of each of the pixel units is intersected at a center of the pixel unit, wherein the pixel units includes a plurality of main pixel units and a plurality of sub pixel units arranged along a direction of the vertical side of the pixel unit and adjacent to each other; and wherein the black matrices, the data lines, the common electrodes and the gate lines are all extended and vertically turned in a z-shaped manner.

In one embodiment of the present invention, further comprising a plurality of light spacers disposed between the pixel units.

Another embodiment of the present invention provides a pixel structure, wherein the pixel structure comprises: a plurality of pixel units, a plurality of black matrices, a plurality of data lines, a plurality of common electrodes and a plurality of gate lines. The pixel units are arranged in an array and adjacent to each other, each of the pixel units, as an optical alignment is performed thereon, having: a horizontal dark line, a vertical dark line, a first horizontal-side dark line, a second horizontal-side dark line, a first vertical-side dark line and a second vertical-side dark line. The horizontal dark line is parallel to a horizontal side of the pixel unit. The vertical dark line is parallel to a vertical side of the pixel unit, and the vertical dark line and the horizontal dark line is intersected to form a crisscross shape. The first horizontal-side dark line is extended from an end of the vertical dark line toward a direction parallel to the horizontal dark line. The second horizontal-side dark line is extended from the other end of the vertical dark line toward the direction parallel to the horizontal dark line, wherein an extending direction of the second horizontal-side dark line is opposite to that of the first horizontal-side dark line. The first vertical-side dark line is extended from an end of the horizontal dark line toward a direction parallel to the vertical dark line. The second vertical-side dark line is extended from the other end of the horizontal dark line toward the direction parallel to the vertical dark line, wherein an extending direction of the second vertical-side dark line is opposite to that of the first vertical-side dark line. The black matrices are disposed along and overlapped with the first vertical-side dark line and the second vertical-side dark line of the pixel units. The data lines are disposed along and overlapped with the first vertical-side dark line and the second vertical-side dark line of the pixel units. The common electrodes are disposed along and overlapped with the first horizontal-side dark line and the second horizontal-side dark line of a part of the pixel units. The gate lines are disposed along and overlapped with the first horizontal-side dark line and the second horizontal-side dark line of the other part of the pixel units, wherein the gate lines and the common electrodes are alternately arranged and parallel to each other.

In one embodiment of the present invention, the horizontal dark line and the vertical dark line of each of the pixel units is intersected at a center of the pixel unit.

In one embodiment of the present invention, the pixel units includes a plurality of main pixel units and a plurality of sub pixel units arranged along a direction of the vertical side of the pixel unit and adjacent to each other.

In one embodiment of the present invention, the pixel units includes a plurality of the red pixel units, a plurality of the green pixel units, a plurality of the blue pixel units sequentially arranged along a direction of the horizontal side of the pixel unit.

In one embodiment of the present invention, the first vertical-side dark line and the second vertical-side dark line of each of the pixel units has a length which is half of that of the vertical side of the pixel unit.

In one embodiment of the present invention, the first horizontal-side dark line and the second horizontal-side dark line of each of the pixel units has a length which is half of that of the horizontal side of the pixel unit.

In one embodiment of the present invention, the black matrices, the data lines, the common electrodes and the gate lines are all extended and vertically turned in a z-shaped manner.

In one embodiment of the present invention, further comprising a plurality of light spacers disposed between the pixel units.

In one embodiment of the present invention, the light spacers are disposed along and overlapped with the black matrices and the data lines.

Furthermore, a further embodiment of the invention provides a liquid crystal panel, wherein the liquid crystal panel comprises: an array substrate, an opposite substrate and a liquid crystal layer disposed between the array substrate and the opposite substrate, a color photoresist layer on the array substrate, and the pixel structure described above disposed in the color photoresist layer.

In comparison with the conventional technologies, the pixel structure and the liquid crystal panel of the present invention improve the opening rate of other area of the pixel structure by disposing and overlapping the black matrices, the data lines, the common electrodes, the gate lines and other elements at the dark lines, thereby improving the display effect of the liquid crystal panel. In particular, it can improve the opening rate of the pixel structure in a color photoresist layer of the array substrate, and the display effect of the liquid crystal panel thereof, of a COA (Color filter on Array) type liquid crystal panel.

To make the above description of the present invention can be more clearly comprehensible, description below in examples of preferred embodiments with the accompanying drawings, described in detail below.

### DESCRIPTION OF THE DRAWINGS

FIG. 1 is a schematic diagram showing dark lines in a pixel unit.

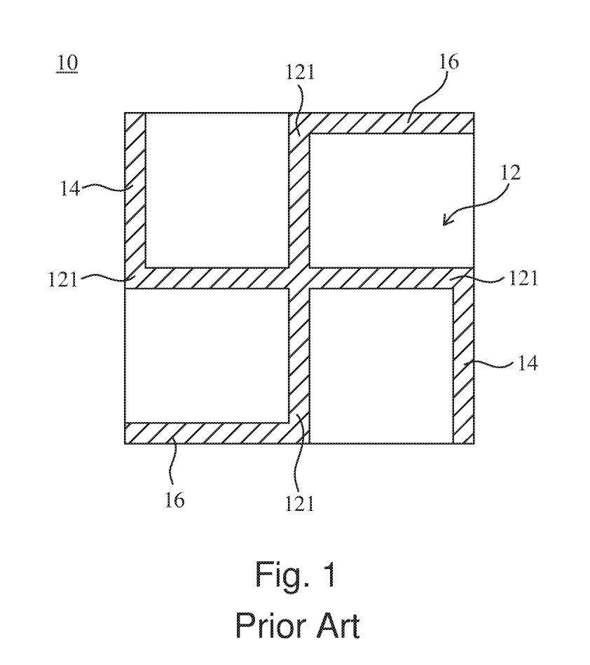

FIG. 2 is a schematic diagram showing a pixel structure of an embodiment of the present invention.

FIG. 3 is a schematic diagram showing a liquid crystal panel of another embodiment of the present invention.

FIG. 4 is a schematic diagram showing a plurality of pixel units of a pixel structure of another embodiment of the present invention.

FIG. 5 is a schematic diagram showing a plurality of pixel units of a pixel structure of a further embodiment of the present invention.

### DETAILED DESCRIPTION OF THE PREFERRED EMBODIMENTS

The following description of the embodiments with reference to the appended drawings is used for illustrating specific embodiments, which may be used for carrying out, of the present invention. Furthermore, the directional terms described by the present invention, such as upper, lower, top, bottom, front, back, left, right, inner, outer, side, around, center, horizontal, lateral, vertical, longitudinal, axial, radial, uppermost or lowermost, and etc., are only directions by referring to the accompanying drawings. Thus, the used directional terms are used to describe and understand the present invention, but the present invention is not limited thereto.

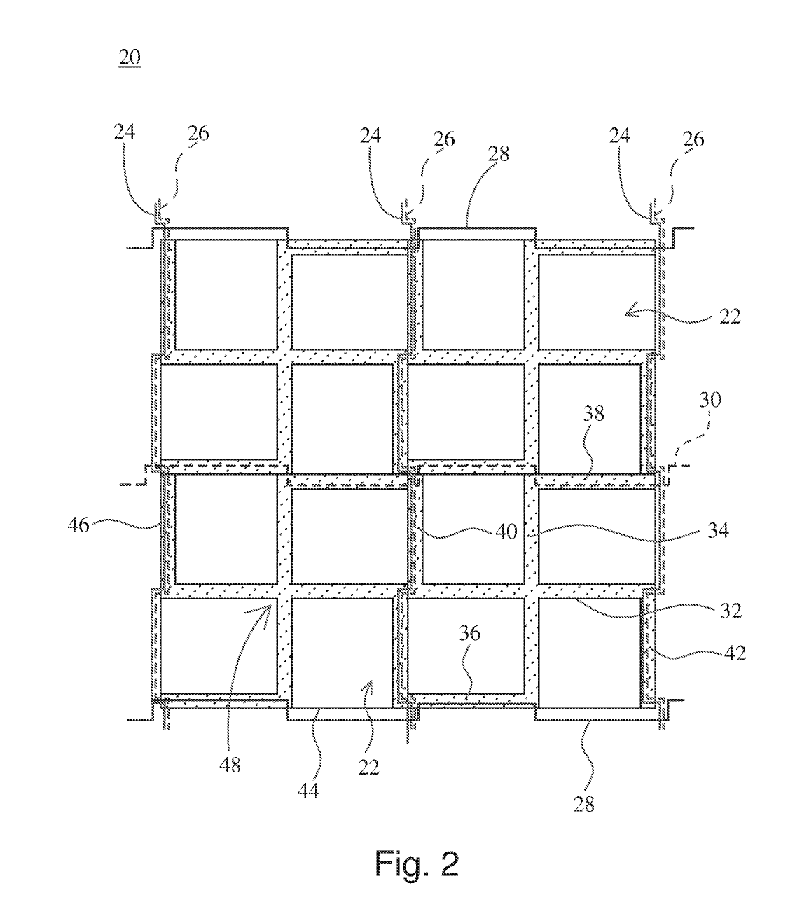

Please referring to FIG. 2, FIG. 2 is a schematic diagram showing a pixel structure of an embodiment of the present invention. The pixel structure 20 includes a plurality of pixel units 22, a plurality of black matrices 24, a plurality of data lines 26, a plurality of common electrodes 28 and a plurality of gate lines 30. The pixel units 22 are arranged in an array and adjacent to each other.

When an optical alignment is performed on the pixel units 22 for automatically directing polymers of an alignment film (not shown) to an irradiation angle of the UV light, each of the pixel units 22 would form a horizontal dark line 32, a vertical dark line 34, a first horizontal-side dark line 36, a second horizontal-side dark line 38, a first vertical-side dark line 40 and a second vertical-side dark line 42. The horizontal dark line 32 is parallel to a horizontal side 44 of the pixel unit 20. The vertical dark line 34 is parallel to a vertical side 46 of the pixel unit 22, and the vertical dark line 34 and the horizontal dark line 32 is intersected to form a crisscross shape. In one embodiment, the horizontal dark line 32 and the vertical dark line 34 of each of the pixel units 22 is intersected at a center 48 of the pixel unit 22. The first horizontal-side dark line 36 is extended from an end of the vertical dark line 34 toward a direction parallel to the horizontal dark line 32. The second horizontal-side dark line 38 is extended from the other end of the vertical dark line 34 toward the direction parallel to the horizontal dark line 32, wherein an extending direction of the second horizontal-side dark line 38 is opposite to that of the first horizontal-side dark line 36. In one embodiment, as shown in FIG. 2, the first horizontal-side dark line 36 is extended leftward, and the second horizontal-side dark line 36 is extended rightward. In another embodiment, the first horizontal-side dark line 36 and the second horizontal-side dark line 38 of each of the pixel units 22 has a length which is half of that of the horizontal side 44 of the pixel unit 22. The first vertical-side dark line 40 is extended from an end of the horizontal dark line 32 toward a direction parallel to the vertical dark line 34. The second vertical-side dark line 42 is extended from the other end of the horizontal dark line 32 toward the direction parallel to the vertical dark line 34, wherein an extending direction of the second vertical-side dark line 42 is opposite to that of the first vertical-side dark line 40. In one embodiment, as shown in FIG. 2, the first vertical-side dark line 40 is extended upward, and the second vertical-side dark line 42 is extended downward. In one embodiment, the first vertical-side dark line 40 and the second vertical-side dark line 42 of each of the pixel units 22 has a length which is half of that of the vertical side 46 of the pixel unit 12.

The black matrices 24 and the data lines 26 are all disposed along and overlapped with the first vertical-side dark line 40 and the second vertical-side dark line 42 of the pixel units 22. Because the black matrices 24 and the data lines 26 would influence the opening rate, disposing locations of these elements are overlapped with those of the first vertical-side dark line 40 and the second vertical-side dark line 42 for improving the opening rate of the pixel structure 10 located at other location. In one embodiment, the black matrices 24 and the data lines 26 are extended and vertically turned in a z-shaped manner.

The common electrodes 28 are disposed along and overlapped with the first horizontal-side dark line 36 and the second horizontal-side dark line 38 of a part of the pixel units 22. The gate lines 30 are disposed along and overlapped with the first horizontal-side dark line 36 and the second horizontal-side dark line 38 of the other part of the pixel units 12, wherein the gate lines 30 and the common electrodes 28 are alternately arranged and parallel to each other. For example, the second horizontal-side dark line 38 in the top of FIG. 2 is overlapped with the common electrode 28; the first horizontal-side dark line 36 and the second horizontal-side dark line 38 in the middle of FIG. 2 is overlapped with the gate line 30; and the first horizontal-side dark line 36 and the second horizontal-side dark line 38 in the bottom of FIG. 2 is overlapped with the common electrode 28. In other words, the gate lines 30 and the common electrodes 28 are alternately arranged and parallel to each other and are overlapped with the first horizontal-side dark line 36 and the second horizontal-side dark line 38. Because the common electrodes 28 and the gate lines 30 influence the opening rate, disposing locations of these elements are overlapped with those of the first horizontal-side dark line 36 and the second horizontal-side dark line 38 for improving the opening rate of the pixel structure 10 located at other location. In one embodiment, the gate lines 30 and the common electrodes 28 are extended and vertically turned in a z-shaped manner.

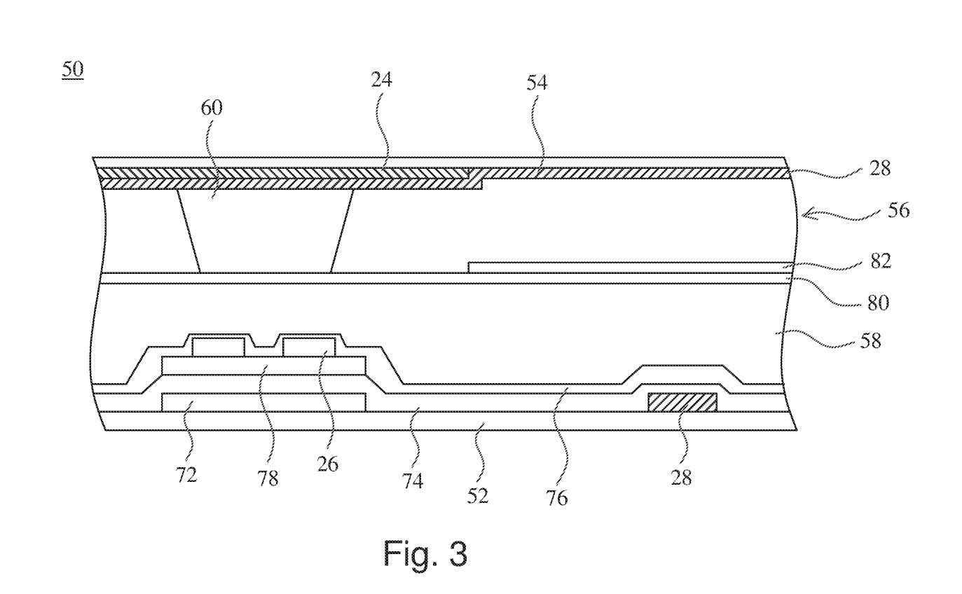

Please referring to FIGS. 2 and 3 together, FIG. 3 is a schematic diagram showing a liquid crystal panel 50 of another embodiment of the present invention. The liquid crystal panel 50 of the present invention belongs to a liquid crystal panel with COA (Color filter on Array) type, which is a technique using to producing a color photoresist layer on a thin film transistor array substrate. The liquid crystal panel 50 comprises an array substrate 52, an opposite substrate 54 and a liquid crystal layer 56 disposed between the array substrate 52 and the opposite substrate 54. A color photoresist layer 58 is on the array substrate 52, and the pixel structure 10 described above is disposed in the color photoresist layer 58. In one embodiment, the pixel unit 22, the data line 26, a part of the common electrode 28 and the gate line 30 (not shown in FIG. 3) are disposed on an inner surface of the array substrate 52, wherein the pixel unit 22 is located in a color photoresist layer 58 on the array substrate 52. In a further embodiment, the black matrix 24 and the other part of the common electrode 28 are disposed on an inner surface of the opposite substrate 54. In another embodiment, the liquid crystal panel 50 further includes a plurality of light spacers 60 disposed in the liquid crystal layer 56 for separating from different liquid crystal areas. From a top view, the light spacers 60 are located at a boundary between the pixel units 12. In a further embodiment, in a top-view direction of the liquid crystal panel 50, the light spacers 60 are disposed along and overlapped with the black matrices 24 and the data line 26. From FIGS. 2 and 3, in the top-view direction of the liquid crystal panel 50, a plurality of devices which may influence the opening rate, such as the black matrix 24, the data line 26, the common electrode 28, the gate line 30 and the light spacer 60, are all disposed and overlapped with the dark lines, so the opening rate at other location of the pixel structure 12 of the liquid crystal panel 50 can be improved thereby improving the display effect of the liquid crystal panel 50. In particular, it can improve the opening rate of the pixel structure 12 in the color photoresist layer 58 of the array substrate 52, and the display effect of the liquid crystal panel thereof, of the COA (Color filter on Array) type liquid crystal panel. In one embodiment, a scanning line 72, two insulating layers 74 and 76, a semiconductor layer 78, a passivation layer 80 and a pixel electrode 82 and other elements, which the liquid crystal panel 50 is required, can be further disposed on the array substrate 52.

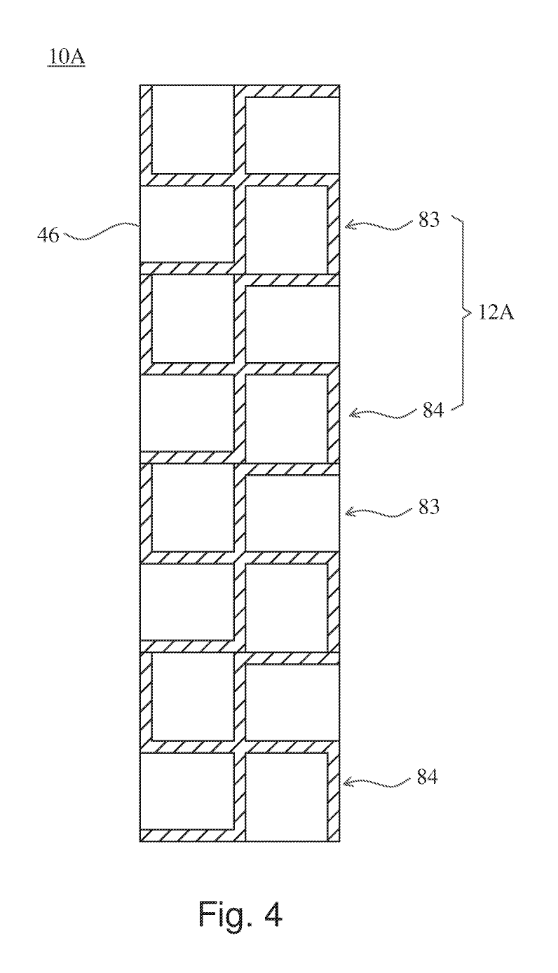

Please referring to FIG. 4, FIG. 4 is a schematic diagram showing a plurality of pixel units 12A of a pixel structure 10A of another embodiment of the present invention. In one embodiment, the pixel units 12A can include a plurality of main pixel units 83 and a plurality of sub pixel units 84 arranged along a direction of the vertical side 46 of the pixel unit 12A and adjacent to each other, wherein the sub pixel unit 64 may assist the main pixel unit 83 for performance level in color

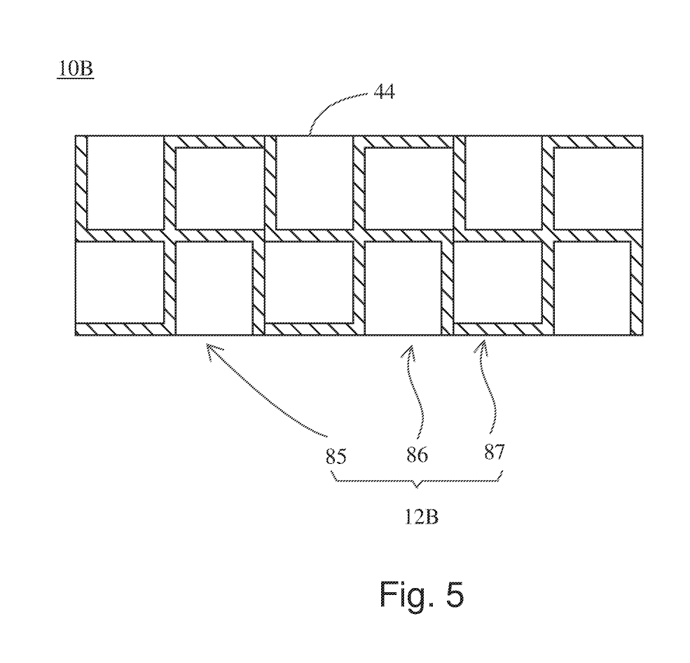

Please referring to FIG. 5, FIG. 5 is a schematic diagram showing a plurality of pixel units 12B of a pixel structure 10B of a further embodiment of the present invention. In another embodiment, the pixel units 12B can include a plurality of red pixel units 85, a plurality of green pixel units 86 and a plurality of blue pixel units 87 arranged along a direction of the horizontal side 44 of the pixel unit 12 and adjacent to each other, for mixing a color to be performed.

The present invention has been described in a preferred embodiment described above. However, the above embodiment is merely in example of performing the present invention. It must be noted that the implementation of the disclosed embodiment does not limit the scope of the invention. On the contrary, modifications and equal settings included in the spirit and scope of the claims are all includes in the scope of the present invention.

What is claimed is:

1. A pixel structure, comprising:
a plurality of pixel units arranged in an array and adjacent to each other, each of the pixel units, as an optical alignment is performed thereon, having:
a horizontal dark line parallel to a horizontal side of the pixel unit;
a vertical dark line parallel to a vertical side of the pixel unit, and the vertical dark line and the horizontal dark line being intersected to form a crisscross shape;
a first horizontal-side dark line extended from an end of the vertical dark line toward a direction parallel to the horizontal dark line;
a second horizontal-side dark line extended from the other end of the vertical dark line toward the direction parallel to the horizontal dark line, wherein an extending direction of the second horizontal-side dark line is opposite to that of the first horizontal-side dark line;
a first vertical-side dark line extended from an end of the horizontal dark line toward a direction parallel to the vertical dark line; and
a second vertical-side dark line extended from the other end of the horizontal dark line toward the direction parallel to the vertical dark line, wherein an extending direction of the second vertical-side dark line is opposite to that of the first vertical-side dark line;
a plurality of black matrices disposed along and overlapped with the first vertical-side dark line and the second vertical-side dark line of the pixel units;
a plurality of data lines disposed along and overlapped with the first vertical-side dark line and the second vertical-side dark line of the pixel units;
a plurality of common electrodes disposed along and overlapped with the first horizontal-side dark line and the second horizontal-side dark line of a part of the pixel units; and
a plurality of gate lines disposed along and overlapped with the first horizontal-side dark line and the second horizontal-side dark line of the other part of the pixel units, wherein the gate lines and the common electrodes are alternately arranged and parallel to each other;
wherein the horizontal dark line and the vertical dark line of each of the pixel units is intersected at a center of the pixel unit;
wherein the pixel units includes a plurality of main pixel units and a plurality of sub pixel units arranged along a direction of the vertical side of the pixel unit and adjacent to each other; and
wherein the black matrices, the data lines, the common electrodes and the gate lines are all extended and vertically turned in a z-shaped manner.

2. The pixel structure according to claim 1, further comprising a plurality of light spacers disposed between the pixel units.

3. A pixel structure, comprising:
a plurality of pixel units arranged in an array and adjacent to each other, each of the pixel units, as an optical alignment is performed thereon, having:
a horizontal dark line parallel to a horizontal side of the pixel unit;
a vertical dark line parallel to a vertical side of the pixel unit, and the vertical dark line and the horizontal dark line being intersected to form a crisscross shape;
a first horizontal-side dark line extended from an end of the vertical dark line toward a direction parallel to the horizontal dark line;
a second horizontal-side dark line extended from the other end of the vertical dark line toward the direction parallel to the horizontal dark line, wherein an extending direction of the second horizontal-side dark line is opposite to that of the first horizontal-side dark line;
a first vertical-side dark line extended from an end of the horizontal dark line toward a direction parallel to the vertical dark line; and
a second vertical-side dark line extended from the other end of the horizontal dark line toward the direction parallel to the vertical dark line, wherein an extending direction of the second vertical-side dark line is opposite to that of the first vertical-side dark line;
a plurality of black matrices disposed along and overlapped with the first vertical-side dark line and the second vertical-side dark line of the pixel units;
a plurality of data lines disposed along and overlapped with the first vertical-side dark line and the second vertical-side dark line of the pixel units;
a plurality of common electrodes disposed along and overlapped with the first horizontal-side dark line and the second horizontal-side dark line of a part of the pixel units; and
a plurality of gate lines disposed along and overlapped with the first horizontal-side dark line and the second horizontal-side dark line of the other part of the pixel units, wherein the gate lines and the common electrodes are alternately arranged and parallel to each other.

4. The pixel structure according to claim 3, wherein the horizontal dark line and the vertical dark line of each of the pixel units is intersected at a center of the pixel unit.

5. The pixel structure according to claim 3, wherein the pixel units includes a plurality of main pixel units and a plurality of sub pixel units arranged along a direction of the vertical side of the pixel unit and adjacent to each other.

6. The pixel structure according to claim 3, wherein the pixel units includes a plurality of the red pixel units, a plurality of the green pixel units, a plurality of the blue pixel units sequentially arranged along a direction of the horizontal side of the pixel unit.

7. The pixel structure according to claim 3, wherein each of the first vertical-side dark line and the second vertical-side dark line of each of the pixel units has a length which is half of that of the vertical side of the pixel unit.

8. The pixel structure according to claim 3, wherein each of the first horizontal-side dark line and the second horizontal-side dark line of each of the pixel units has a length which is half of that of the horizontal side of the pixel unit.

9. The pixel structure according to claim 3, wherein the black matrices, the data lines, the common electrodes and the gate lines are all extended and vertically turned in a z-shaped manner.

10. The pixel structure according to claim 3, further comprising a plurality of light spacers disposed between the pixel units.

11. The pixel structure according to claim 10, wherein the light spacers are disposed along and overlapped with the black matrices and the data lines.

12. A liquid crystal panel, comprising: an array substrate, an opposite substrate and a liquid crystal layer disposed between the array substrate and the opposite substrate, a color photoresist layer on the array substrate, and a pixel structure disposed in the color photoresist layer, the pixel structure comprising:
a plurality of pixel units arranged in an array and adjacent to each other, each of the pixel units, as an optical alignment is performed thereon, having:
a horizontal dark line parallel to a horizontal side of the pixel unit;
a vertical dark line parallel to a vertical side of the pixel unit, and the vertical dark line and the horizontal dark line being intersected to form a crisscross shape;
a first horizontal-side dark line extended from an end of the vertical dark line toward a direction parallel to the horizontal dark line;
a second horizontal-side dark line extended from the other end of the vertical dark line toward the direction parallel to the horizontal dark line, wherein an extending direction of the second horizontal-side dark line is opposite to that of the first horizontal-side dark line;
a first vertical-side dark line extended from an end of the horizontal dark line toward a direction parallel to the vertical dark line; and
a second vertical-side dark line extended from the other end of the horizontal dark line toward the direction parallel to the vertical dark line, wherein an extending direction of the second vertical-side dark line is opposite to that of the first vertical-side dark line;
a plurality of black matrices disposed along and overlapped with the first vertical-side dark line and the second vertical-side dark line of the pixel units;
a plurality of data lines disposed along and overlapped with the first vertical-side dark line and the second vertical-side dark line of the pixel units;
a plurality of common electrodes disposed along and overlapped with the first horizontal-side dark line and the second horizontal-side dark line of a part of the pixel units; and
a plurality of gate lines disposed along and overlapped with the first horizontal-side dark line and the second horizontal-side dark line of the other part of the pixel units, wherein the gate lines and the common electrodes are alternately arranged and parallel to each other.

13. The liquid crystal panel according to claim 12, wherein the horizontal dark line and the vertical dark line of each of the pixel units is intersected at a center of the pixel unit

14. The liquid crystal panel according to claim 12, wherein the pixel units includes a plurality of main pixel units and a plurality of sub pixel units arranged along a direction of the vertical side of the pixel unit and adjacent to each other.

15. The liquid crystal panel according to claim 12, wherein the pixel units includes a plurality of the red pixel units, a plurality of the green pixel units, a plurality of the blue pixel units sequentially arranged along a direction of the horizontal side of the pixel unit.

16. The liquid crystal panel according to claim 12, wherein each of the first vertical-side dark line and the second vertical-side dark line of each of the pixel units has a length which is half of that of the vertical side of the pixel unit.

17. The liquid crystal panel according to claim 12, wherein each of the first horizontal-side dark line and the second horizontal-side dark line of each of the pixel units has a length which is half of that of the horizontal side of the pixel unit.

18. The liquid crystal panel according to claim 12, wherein the black matrices, the data lines, the common electrodes and the gate lines are all extended and turned in a z-shaped manner.

19. The liquid crystal panel according to claim 12, further comprising a plurality of light spacers disposed between the pixel units.

20. The liquid crystal panel according to claim 19, wherein the light spacers are disposed along and overlapped with the black matrices and the data lines.
